(19) United States
(12) Patent Application Publication
(10) Pub. No.: US 2015/0127191 A1
(43) Pub. Date: May 7, 2015

(54) VEHICULAR NETWORK

(71) Applicants: Saswat Misra, New York, NY (US); Jari Hämäläinen, Kangasala As (FI); Andrew K. Lang, New York, NY (US); Ismail Mohamud, Flower Mound, TX (US)

(72) Inventors: Saswat Misra, New York, NY (US); Jari Hämäläinen, Kangasala As (FI); Andrew K. Lang, New York, NY (US); Ismail Mohamud, Flower Mound, TX (US)

(21) Appl. No.: 14/535,304

(22) Filed: Nov. 6, 2014

Related U.S. Application Data
(60) Provisional application No. 61/900,861, filed on Nov. 6, 2013.
(60) Provisional application No. 61/900,871, filed on Nov. 6, 2013.
(60) Provisional application No. 61/900,874, filed on Nov. 6, 2013.
(60) Provisional application No. 61/900,886, filed on Nov. 6, 2013.
(60) Provisional application No. 61/900,895, filed on Nov. 6, 2013.
(60) Provisional application No. 61/900,900, filed on Nov. 6, 2013.
(60) Provisional application No. 61/900,911, filed on Nov. 6, 2013.
(60) Provisional application No. 61/900,918, filed on Nov. 6, 2013.

(51) Int. Cl. G01C 21/26; G07C 5/00

(52) U.S. Cl. CPC G01C 21/26; G07C 5/008
USPC 701/1

(57) ABSTRACT

Disclosed herein are techniques for determining a vehicle-based reputation. A driver of a remote vehicle is identified at a navigation system. Driving of the driver is characterized based on the occurrence of one or more events. Transmission of the characterization is caused to a remote server. Also disclosed herein are techniques for determining a vehicle condition. A remote vehicle is identified at a navigation system. A condition of the remote vehicle is characterized based on the occurrence of one or more events. A transmission of the characterization is caused to a remote server.

### RELATED APPLICATIONS

This application claims priority from U.S. Provisional Patent Application Ser. No. 61/900,861 filed on Nov. 6, 2013; Ser. No. 61/900,871 filed on Nov. 6, 2013; Ser. No. 61/900,874 filed on Nov. 6, 2013; Ser. No. 61/900,886 filed on Nov. 6, 2013; Ser. No. 61/900,895 filed on Nov. 6, 2013; Ser. No. 61/900,900 filed on Nov. 6, 2013; Ser. No. 61/900,911 filed on Nov. 6, 2013; Ser. No. 61/900,918 filed on Nov. 6, 2013.

### FIELD

The present disclosure relates to users and systems for vehicular-networks and more particularly to a reputation-based and condition-based vehicular network and, more particularly, to collecting information to contribute to rating other vehicles and viewing information on the aggregate ratings of other vehicles, disseminating routing information to other vehicles to, inter alia, ease traffic congestion and reduce accidents and near accidents, localized registration and viewing of driving information in a navigation tool, systems and methods for providing guidance instructions to a user that take into account parking space availability and for managing a network-based parking management, operation techniques for selecting and playing electronic engine sounds, e.g., as a pedestrian safety measure, and providing exercise path directions to a user and, more particularly, to providing a surprise exercise path to a user based on certain types of user-specific and crowd-sourced data.

### BACKGROUND

A large number of vehicular accidents on the road are preventable. In particular, certain cars are functionally unreliable and certain poor drivers contribute to more than their “fair share” of accidents on the road. Suspect cars and drivers are typically identified by police officers and automated and stationary equipment (e.g., red light cameras). Once identified, an owner of the vehicle or the driver is assessed a fine. Further, drivers may have their licenses revoked if caught driving dangerously on one or more occasions. Similarly, a vehicle may be determined to be unsafe during a regular government-mandated vehicle inspection. Once detected, registration tags of the unsafe vehicle may be revoked.

These techniques for identifying and avoiding unsafe cars and drivers have limitations. First, it generally takes a very long time to identify and remove an unsafe vehicle or driver from the road. For example, a person who habitually drives while under the influence of alcohol may conduct a large number of trips before they are caught a single time by police (and even though other cars on the highway with the drunk driver can clearly observe that the driver is impaired). Second, government-imposed penalties tend to have an “all or nothing” effect. While the penalties remove some clearly terrible drivers and cars from the road, they do not remove or help ease the burden of co-existing with drivers or cars that are merely poor and accident prone. Finally, some drivers are aware of particular police and automated checkpoints and habitually make efforts to avoid a few locations where they know that their behavior will likely be subject to review.

A large number of vehicular accidents on the road are preventable. In particular, many accidents happen when a lead vehicle “suddenly” changes a manner in which they are driving. This sudden change comes as a surprise to a driver of a following or neighboring vehicle and an accident results. Typical sudden changes leading to accidents are rapid deceleration, abrupt left or right turns, frequent lane changes, or lane bypass maneuvers.

The use of navigation-based applications is widespread. Typically, a user enters their driving information into navigation software, whether through a built-in navigation system, a third-party mounted system, a tablet, smartphone, or some other device, and the user is provided with a series of turn-by-turn directions and/or audio routing the user to their destination. Routing information generated in a navigation system one vehicle is generally not directly used by any other vehicle on the road.

Existing vehicle navigation systems typically provide information on well-known and obvious attractions such as shopping malls, parks, and restaurants that happen to be located along a driving path even without an explicit user request for such information. The particular attractions that appear in navigation system databases are typically controlled by a single organization or entity. For example, a provider of a navigation software package may have the final and only say on which attractions are included and “pop up” on navigation maps from its own navigation software. Further, in some instances, the organization or entity in control of the navigation software is simply unaware of attractions that merit display on a navigation map. Further, navigation software updates are pushed to users relatively infrequently (e.g., once every few months) meaning that hour-long, day-long, and week-long attractions (e.g., a yard sale or state fair) are not typically available to users of existing navigation systems.

Existing vehicle-based navigation systems typically route a user directly to a specific destination specified by the user (e.g., a museum or shopping site). In most cases, however, the user will not park directly at the destination, but rather in a parking space that may be located some distance away. A few existing approaches attempt to address the need of a user to find parking at a location other than his or her ultimate destination. For example, U.S. Pat. No. 8,532,923 relates to a navigation system in which a car's navigation system locally pushes walking directions to a driver's cell phone upon the car being parked. The walking directions attempt to guide the driver from his or her parking space to an intended destination.

As another example, European Patent Application No. 1030167A1 describes a navigation system in which a car continually calculates walking directions to a destination while the driver is en route to the destination. The car periodically provides alerts to the driver suggesting that the driver park the car and walk based on the car's current location.

One drawback of the prior systems is that they provide walking directions in based on where a driver currently happens to be positioned at the time that the directions are provided (e.g., at a time when it is determined that a driver has parked their car). Accordingly, it would be desirable to provide a driver with parking-based directions ahead of the time that the user arrives at a parking space so that the directions may be optimized and so that the driver is provided sufficient notice of the location of the parking space.

Another drawback of the prior art system is that the transfer of driving directions from a vehicle to walking directions on a mobile phone is performed via a local “push” operation between the car and the mobile phone. Such data may be stale or out of data. Accordingly, it is desirable to perform this transfer using real-time network-based data.

Further, the parking spaces available in existing navigation systems are typically owned and operated by third parties other than a party that provides the navigation software. Accordingly, existing navigation systems are unable to provide a well-integrated package of parking space based guidance, ticketing and metering, and payment management (e.g., charges and refunds) integrated into a single navigation tool. Accordingly, it would be desirable to integrate all of these features of parking space management and maintenance into a single platform that is accessible both from a user's vehicle navigation system and mobile device.

Historically, most medium and large vehicles (e.g., cars, trucks, buses, motorcycles, mopeds) produced significant amounts of engine noise. While this noise was frequently regarded as distracting and as an annoyance, it did have at least one beneficial effect. Engine sounds effectively acted as a safety measure. A person could infer that a vehicle was close and/or approaching based on an engine sound that the vehicle produced. The person could and thus stay away from a route of the vehicle. Newer electric engines, however, generate far less noise than older engine technology. Similarly, advances in traditional engine technology have also made those engines quieter than ever before. Because people are accustomed to the sound of an approach vehicle, they sometimes have difficulty noticing an approaching modern vehicle.

Manufacturers and third-parties (“parties”) currently advertise vehicle recall and maintenance needs to vehicle owners using a number of techniques. First, these parties may use postal mail or e-mail to inform vehicle owners of recall and maintenance needs. Second, these parties may distribute information to official car dealerships and rely on customers to become informed through subsequent in-store visits. Third, these parties may run advertisements on TV, in print, and on the Internet.

While these techniques are widespread, they suffer from several disadvantages that prevent complete dissemination of recall and maintenance information to customers. For example, vehicle owners will not receive recall and maintenance information if they have changed their traditional address or e-mail address without informing the parties. Further, an owner who habitually uses independent repair shops is substantially less likely to receive recall or maintenance information as compared to owners who use more expensive official dealer services. Still further, an owner may not be aware of print, TV, or Internet advertisements placed by the parties. Finally, these parties are not always aware of the sale of vehicles from a first owner to a second owner and may not readily be able to reach the second owner to provide information on the recall or maintenance needs.

Running, walking, biking, and swimming are recognized as enjoyable forms of exercise that provide many health benefits when done regularly. One challenge many people face adhering to a regular exercise schedule is a lack of variety in their running, walking, biking, or swimming path (hereinafter, “path”). In other words, continually traversing the same exercise path, or the same small number of exercise paths, leads to boredom. This boredom due to a lack of exercise path variety may cause some exercisers to stop exercise or reduce the regularity of their exercising.

Existing routing systems for recommending running, walking, biking, or swimming paths typically focus on a few key objective criteria that only tangentially deal with qualities of an exercise path itself. For example, typical exercise path recommendations are based on an expected time required to complete the activity by the exerciser, a number of calories to be burned by the exerciser, or other factors specific to the exerciser but only tangentially related to the path itself. Similarly, most exercise path recommendation systems recommend a same path day-in and day-out unless a user of the path recommendation system changes these key objective criteria so as to produce a different route. Finally, many crowd-sourced recommendations focus on providing real-time alerts and directions in response to very short term changes in properties that may existing along a desired exercise path.

### SUMMARY

Accordingly, presented herein are techniques for a reputation- and condition-based vehicular network and, more particularly, to collecting information to contribute to rating other vehicles and viewing information on the aggregate ratings of other vehicles. In more detail, disclosed herein are techniques for determining vehicle-based reputations. A driver of a remote vehicle is identified at a navigation system. The driving of the driver is characterized based on the occurrence of one or more events. Transmission of the characterization is caused to a remote server. Also disclosed herein are techniques for determining a vehicle condition. A remote vehicle is identified at a navigation system. A condition of the remote vehicle is characterized based on the occurrence of one or more events. A transmission of the characterization is caused to a remote server.

Accordingly, presented herein are techniques for disseminating routing information to other vehicles to, inter alia, ease traffic congestion and reduce accidents and near accidents. In more detail, disclosed herein are techniques for providing routing information to a vehicle. A second vehicle is identified at a first vehicle, where the identification is based on a proximity of second vehicle and the first vehicle. The first vehicle accesses predicted or actual information on a next navigational routing step associated with the second vehicle. A display of the predicted or actual information is caused on a screen.

Accordingly, presented herein are techniques for a localized registration and viewing of driving information in a navigation tool. In more detail, disclosed herein are techniques for displaying local points of interest on a navigation map. A navigation session is initiated at a vehicle. A location of the vehicle is provided to a remote server. Information on local points of interest in the vicinity of the vehicle's location are received from the remote server. The local point of interest is displayed on the navigation map.

Accordingly, presented herein are techniques for parking management and guidance (e.g., navigation) and, more particularly, systems and methods for providing guidance instructions to a user that take into account parking space availability and for managing a network-based parking management operation.

Disclosed herein are techniques for providing combined driving and walking directions. Identification of a first destination provided by a user is received via a navigation input. Instructions to display, via a navigation display, driving directions to a second destination are generated, where the second destination corresponds to a parking space in the general vicinity of the first destination. It is determined that the user has arrived at the second destination. A wireless transmission of a message to a server is caused, wherein the server is located remotely from the user, and where the message results in the providing of walking directions from the second destination to the first destination to a mobile device of the user.

Accordingly, disclosed herein are techniques for managing parking space allotments. A parking space is assigned to a first vehicle. Subsequent to the assigning, a presence of an unauthorized second vehicle in the parking space is identified. A message is generated indicating that the second unauthorized vehicle is in violation. A message is generated intended for the first vehicle informing the first vehicle of the violation. Also disclosed herein are techniques related to a parking space database. The parking space database includes information on privately-owned spaces registered by private owners of the spaces with a management company for use during specified times, exclusively-owned spaces owned by the management company, and authority-granted spaces owned by one or more of a local municipality and city, state, or federal government.

Accordingly, presented herein techniques for selecting and playing electronic engine sounds, e.g., as a pedestrian safety measure. Disclosed herein are techniques for playing engine sounds from a vehicle. A database of candidate engine sounds is accessed. At least one additional engine sound is added to the database. While the vehicle is in motion, an engine sound from the database including the additional engine sound is selected based on automatic detection of an occurrence of a pre-defined event. The engine sound is played after the selection.

Accordingly, presented herein are network-based techniques for notifying vehicle owners of vehicle recall and maintenance needs and for identifying vehicles that require such service. In more detail, disclosed herein are techniques for determining a service priority order for one or more customer vehicles. Information identifying recall or maintenance information for a set of vehicles is received. A recall or maintenance reply messages from one or more customer vehicles is received. A service priority order for servicing the one or more customer vehicles is determined based on the received recall or maintenance reply messages.

Accordingly, presented herein are techniques for providing provide crowd-sourced exercise path directions to a user that take into account subjective details inherent to an exercise path, that provide a user will a different routes even when the same basic route criteria are specified, and that are based on crowd-sourced data that may be pertinent for days, week, months, or years, rather than during, e.g., a few hours.

In more detail, disclosed herein are techniques for providing a recommended exercise path to a user. An indication of an exercise mode of the user is received. One or more objective constraints for an exercise path of the user are determined. One or more subjective user preferences for the exercise path of the user are determined. A randomized exercise path is determined based on the exercise mode, the one or more objective constraints, and the one or more subjective user preferences. The randomized exercise path is provided to the user as the recommended exercise path.

Disclosed is a method for providing combined driving and walking directions comprising receiving, via a navigation input, identification of a first destination provided by a user; generating instructions to display, via a navigation display, driving directions to a second destination, the second destination corresponding to a parking space in the general vicinity of the first destination; determining that the user has arrived at the second destination; and causing a wireless transmission of a message to a server, said server located remotely from the user, said message resulting in the providing of walking directions from the second destination to the first destination to a mobile device of the user.

The method comprises identifying the second destination (a) substantially after the receiving of the first destination and (b) in response to a determination that the user is relatively close to the first destination.

The method comprises identifying the second destination substantially ahead of an estimated time at which the user will arrive at either the first destination or the second destination.

The method comprises identifying the second destination further comprises determining the second destination based on optimizing an estimated time required to walk to the first destination from a plurality of potential parking spaces.

According to the method, the navigation input is located at a mobile device.

According to the method, the navigation input is located on a vehicle-based navigation system.

Disclosed is a method for managing parking space allotments, the method comprising: assigning a parking space to a first vehicle; subsequent to the assigning, identifying a presence of a unauthorized second vehicle in the parking space; generating a message indicating the second unauthorized vehicle is in violation; and generating a message intended for the first vehicle informing the first vehicle of the violation.

According to the method, the identifying is based on a notification provided by a bystander vehicle based on a camera-mounted observation of the bystander vehicle.

The method comprises causing the message indicating the second unauthorized vehicle is in violation to be provided to both a government sponsored enforcement agency and the owner of the unauthorized vehicle.

The method comprises rerouting the first vehicle to a third destination, said third destination corresponding to an alternate parking space.

Disclosed is a parking space database comprising: privately-owned spaces registered by private owners of the spaces with a management company for use during specified times; exclusively-owned spaces owned by the management company, and authority-granted spaces owned by one or more of a local municipality and city, state, or federal government.

According to the method, vacancy information for each of the privately-owned spaces, exclusively-owned spaces, and authority-granted spaces is regularly updated based on reports received bystander vehicles.

Disclosed is a method for playing engine sounds from a vehicle, said method comprising: accessing a database of candidate engine sounds; adding at least one additional engine sound to the database; while the vehicle is in motion, selecting an engine sound from the database including the additional engine sound based on automatic detection of an occurrence of a pre-defined event; and playing the engine sound after the selection.

According to the method, the occurrence of a pre-defined event comprises detecting a presence of a pedestrian in vicinity of the vehicle.

According to the method, playing the engine sound after the selection comprises: determining an angle and a distance associated with the pedestrian; and adjusting a directionality and volume of the playing based on the determined angle and distance.

According to the method, the database of candidate engine sounds is stored on a server remote to the vehicle.

According to the method, the pre-defined event comprises detecting than the vehicle is in vicinity of a pedestrian crosswalk.

Disclosed is a method for determining a service priority order for one or more customer vehicles, the method comprising: receiving information identifying recall or maintenance information for a set of vehicles; receiving recall or maintenance reply messages from one or more customer vehicles; and determining a service priority order for servicing the one or more customer vehicles based on the received recall or maintenance reply messages.

The method comprises causing transmission of a wireless recall or maintenance broadcast message; and in response to causing the transmission, receiving the recall or maintenance reply messages from one or more customer vehicles.

The method comprises transmitting the service priority order to the one or more customer vehicles.

According to the method, a recall or maintenance reply message from a given one of the one or more customer vehicles comprises information identifying (a) whether service has been performed on the given one of the one more customer vehicles and (b) a status of a maintenance unit or subsystem of the one of the one or more customer vehicles that is subject of the recall or maintenance information.

According to the method, the service priority order is based on statuses of maintenance units or subsystems of the one or more customer vehicles.

Disclosed is a method for providing a recommended exercise path to a user, the method comprising: receiving an indication of an exercise mode of the user; determining one or more objective constraints for an exercise path of the user; determining one or more subjective user preferences for the exercise path of the user; accessing a randomized exercise path based on the exercise mode, the one or more objective constraints and the one or more subjective user preferences; and providing the randomized exercise path to the user as the recommended exercise path.

According to the method, accessing the randomized exercise path comprises constructing an exercise path based on a plurality of path segment analyses, wherein each path segment analysis in the plurality comprises: accessing a characterization of the path segment according to the one or more objective constraints, the one or more objective constraints, and the exercise mode; and determining if the path segment is suitable for inclusion in the exercise path based on the accessed characterization.

According to the method, the accessed characterization is based on crowd-sourced data.

According to the method, the randomized exercise path is based on a history of one or more past exercise paths at least started by the user.

According to the method, the one or more objective constraints comprise elevation data associated with the exercise path.

According to the method, the one or more subjective user preferences for the exercise path comprises a scenic beauty of the exercise path, a degree of variety in the natural surroundings over the duration of the exercise path, a presence of wildlife along the exercise path, and a degree of perceived safety along the exercise path.

According to the method, the exercise mode is one of biking or swimming.

### BRIEF DESCRIPTION OF DRAWINGS

Aspects and features of the presently-disclosed systems and methods will become apparent to those of ordinary skill in the art when descriptions thereof are read with reference to the accompanying drawings, of which:

FIG. 1 depicts an illustrative process for collecting information to contribute to ratings of other vehicles or drivers in accordance with an embodiment; and

FIG. 2 depicts an illustrative process for viewing information on the aggregate ratings of other vehicles on a display in accordance with an embodiment.

FIG. 3 depicts an illustrative process for providing routing information of one vehicle to another vehicle in accordance with an embodiment; and

FIG. 4 depicts an illustrative process for coordinating a bypass of a vehicle in accordance with an embodiment.

FIG. 5 depicts an illustrative remote server-based process for displaying local points of interest on a navigation map in accordance with an embodiment.

FIG. 6 depicts an illustrative process for guiding a user to a parking space and to a destination in accordance with an embodiment; and

FIG. 7 depicts an illustrative process for identifying and handling parking space violations in accordance with an embodiment.

FIG. 8 depicts an illustrative process for guiding a user to a parking space and to a destination in accordance with an embodiment; and

FIG. 9 depicts an illustrative process for identifying and handling parking space violations in accordance with an embodiment.

FIG. 10 depicts an illustrative process for selecting and playing electronic engine sounds using a smart vehicle, e.g., as a pedestrian safety measure, in accordance with an embodiment.

FIG. 11 depicts an illustrative network-based process for collecting vehicle information and transmitting service priority order information to vehicles in accordance with an embodiment; and

FIG. 12 depicts an illustrative network-based process for deploying vehicle recall or maintenance resources in a region in accordance with an embodiment.

FIG. 13 depicts an illustrative process for crowd-sourcing path data from walkers, runners, swimmers, and/or bikers in accordance with an embodiment; and

FIG. 14 depicts an illustrative process for recommending a path to a walker, runner, biker, and/or swimmer in accordance with an embodiment.

### DETAILED DESCRIPTION

Hereinafter, embodiments of the presently-disclosed systems and methods for collecting information to contribute to rating other vehicles and viewing information on the aggregate ratings of other vehicles. Like reference numerals may refer to similar or identical elements throughput the description of the figures.

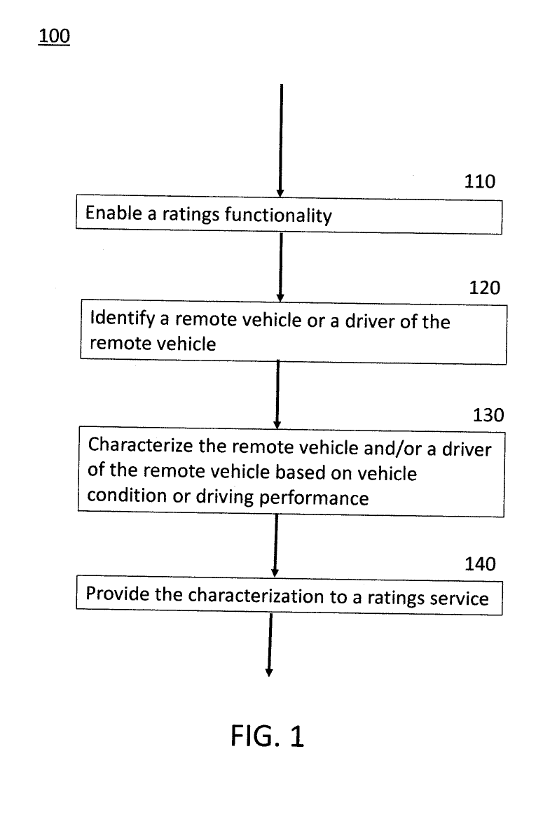

FIG. 1 depicts an illustrative process for collecting information to contribute to ratings of other vehicles or drivers in accordance with an embodiment. In arrangements, the process 100 is executed by navigation software and an associated communications system present on a smartphone, tablet, factory-installed navigation system, third-party mounted navigation system, laptop, portable digital assistant (PDA), or smart watch device. For illustrative purposes, it will be assumed in the following description that navigation software and the associated communications system performs the process 100. Further, the navigation software and the associated communications system will be referred to as a “navigation system” hereinafter.

At 110, a navigation system residing in a first vehicle enables a ratings functionality. With this functionality enabled, the navigation system of the first vehicle is able observe and record information on other vehicles on the road. Such information includes:

(1) Vehicle condition. The first vehicle is able to record information on the condition of vehicles in its vicinity. Such information includes one or more of information on broken lights (e.g., a broken tail light), tire condition (e.g., under inflated, over inflated, use of a safety/spare tire), towing of a heavy load (e.g., towing a load heavy enough to materially compromise handling and responsiveness of the vehicle), and unsecured cargo (e.g., a pickup truck hauling large rocks without any covering to secure those rocks); and
(2) Driver performance. The first vehicle is able record information on the driving quality observed in relation to other vehicles in its vicinity. Such information includes information on aggressive driving, speeding, tailgating, erratic driving (e.g., repeated and oscillatory lane changes in a short period of time).

In arrangements, the navigation system of the first vehicle records information on vehicle condition and driver performance of other vehicles by communicating with one or more outwards-facing cameras mounted to the first vehicle. In arrangements, the navigation system of the first vehicle records information on vehicle condition and driver performance of other vehicles by communicating with one or more radar and/or sonar based systems mounted to the first vehicle.

A large number of techniques can be used to enable the ratings functionality associated with the navigation system of the first vehicle. In arrangements, the ratings functionality is activated upon vehicle start. In arrangements, the ratings functionality is activated upon a driver of the first vehicle (“first driver”) activating a navigation system, or upon the first driver specifically activating the ratings functionality of the navigation system via a touchscreen, keypad, or audible command. In arrangements, the ratings functionality is activated by the first user from a mobile application operating on the user's mobile phone, tablet, laptop, smart watch, or other portable device.

At 120, the navigation system residing a first vehicle identifies a remote vehicle or a driver of the remote vehicle. To identify a remote vehicle, the first vehicle may use any suitable mobile-to-mobile communications protocol (e.g., an LTE Direct protocol or a line-of-sight based protocol). Alternatively, to identify a remote vehicle, the first vehicle may communicate with a remote third party server. In particular, the third party server may maintain the location of vehicles on the roadway and provide this information to the navigation system of the first vehicle.

To identify a driver of a remote vehicle, the first vehicle may rely on an identification (ID) provided by the driver before or during operation of the remote vehicle. Once provided, this ID may be communicated to the first vehicle either through a broadcast vehicle-to-vehicle communications link or through a remote server intermediary. Insurance companies or other government agencies may require or encourage drivers to broadcast their ID to other vehicles on the roadway. In arrangements, the ID may be supplied by the Enhanced Driver's License (EDL) at a time that the driver starts the vehicle. The EDL contains an RFID which can be programmed to provide the ID for reputation ratings purposes.

At 130, the navigation system of the first vehicle may characterize a remote vehicle and/or a driver of the remote vehicle based on vehicle condition or driving performance. In particular, the navigation system will attempt to characterize vehicle condition for any vehicles in its vicinity using its cameras, radar, and/or sonar detectors and by focusing on a set of predefined “events,” e.g., broken lights (e.g., a broken tail light), tire condition (e.g., under inflated, over inflated, use of a safety/spare tire), towing of a heavy load (e.g., towing a load heavy enough to materially compromise handling and responsiveness of the vehicle), and unsecured cargo (e.g., a pickup truck hauling large rocks without any covering to secure those rocks). The navigation system records any events that are “detected” based on its observations as well as an associated vehicle identifier. In addition, if a vehicle's condition appears to be satisfactory, the navigation system may also record this information as an “event.”

Similarly, at 130, the navigation system may characterize driving performance of a driver. In particular, the navigation system will attempt to characterize a driving performance for any driver that it can observe in its vicinity using its cameras, radar, and/or sonar detectors and by focusing on a set of predefined “events,” e.g., an aggressive driving event, a speeding event, a tailgating event, or an erratic driving event. The navigation system records any events that are “detected” based on its observations as well an ID associated with the driver.

In addition, if a driver's driving performance appears to be satisfactory, the navigation system may also record this information as an occurrence of an “event.” Whether a driver's performance appears satisfactory or not, the first vehicle's navigation system also notes an amount of time over which a particular driver was under observation (this is because, e.g., a driver who committed three sudden deceleration movements during two minutes of observation may be a different type of driver than one who committed three sudden deceleration movements during two hours of observation).

At 140, the navigation system of the first vehicle provides the characterizations derived at 130 to a ratings service. In arrangements, the first vehicle transmits this information to a remote server via a cellular, WiFi, or other suitable wireless connection. The ratings service collects the characterizations and observations made from a wide range of reporting vehicles over a wide range of time and produces a rating for each vehicle and each driver for which it has collected sufficient data. In some arrangements, the condition of each vehicle is rated on a scale from 1 to 100, where 1 indicates a very poor condition vehicle and 100 indicates a very well-maintained vehicle. In some arrangements, the driving performance of each driver is rated on a scale from 1 to 100, wherein 1 indicates very poor driving performance and 100 indicates very high quality and safe driving.

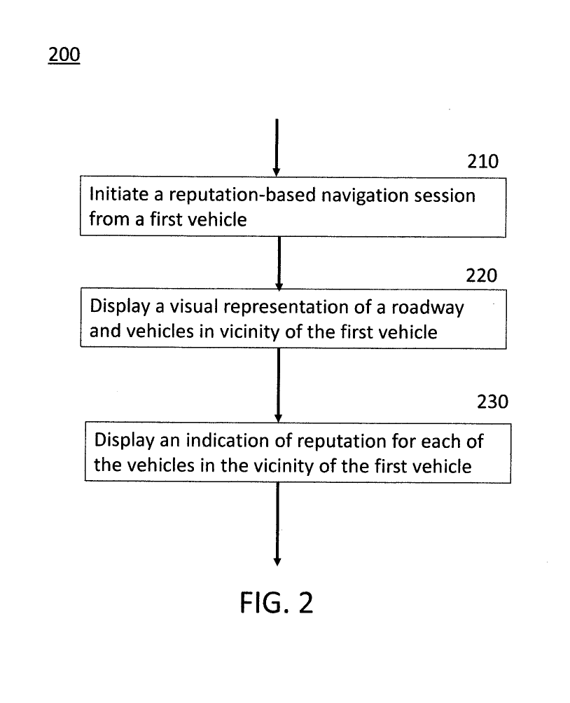

FIG. 2 depicts an illustrative process for viewing information on the aggregate ratings of other vehicles on a display in accordance with an embodiment. In arrangements, the process 200 is executed by navigation software and an associated communications system present on a smartphone, tablet, factory-installed navigation system, third-party mounted navigation system, laptop, PDA, or smart watch device. For illustrative purposes, it will be assumed in the following description that navigation software and the associated communications system performs the process 200. Further, the navigation software and the associated communications system will be referred to as a “navigation system” hereinafter.

At 210, a first vehicle initiates a reputation-based navigation session. The session may be started when the first driver starts his or her vehicle or when the first driver “turns on” the navigation system of his or her car. At 220, a visual representation of a road in vicinity of the first vehicle is displayed. The visual representation is initiated when the first driver selects any function that involves a simulated “road map” on the navigation system (i.e., a map showing a roadway, an indication of where the first vehicle is located along the roadway and possibly other features such as representations of buildings, foliage, and on and off ramps).

At 230, the visual representation of 220 is populated with indications of vehicles in vicinity of the first vehicle and, for each of the vehicles in the vicinity of the first vehicle, an indication of that vehicle's condition and/or that vehicle's driver's reputation (“condition and/or reputation information”). In arrangements, the information of 230 is automatically pre-populated on all or many roadmaps of the navigation system. In arrangements, a user of the navigation system must choose a particular menu option to “enable” condition and/or reputation information to be overlaid on top of a conventional navigation road map. The condition and/or reputation information may be stored locally by the navigation system of the first vehicle or the navigation system of the first vehicle may download condition and/or reputation system information from a remote server (operated by the same company that operates the navigation system or operated by a third party) such as the server described in relation to the process 100 (FIG. 1).

The indication of reputation and/or condition information may be a colored circle surrounding a given vehicle on a display, where the color of the circle corresponds to a condition of the vehicle, a reputation of the driver, or a combined indication that depends on both factors. Additionally or alternatively, a numerical score may be displayed on the screen adjacent to a given vehicle (the score moves to coincide with vehicle movements across the screen), where the numerical score specifies a condition of the vehicle, a reputation of a driver of the vehicle, or a combined score that depends on both factors. In this way, the first driver, upon using the navigation system of the first vehicle, is able to quickly determine if any “noteworthy” vehicles or drivers (e.g., very low reputation drivers) are in his or her immediate surrounding area. The driver of the first vehicle can then take action (e.g., speed up or slow down) to avoid being in proximity to low-reputation vehicles and driver and, as such, can reduce a chance of being involved in an accident.

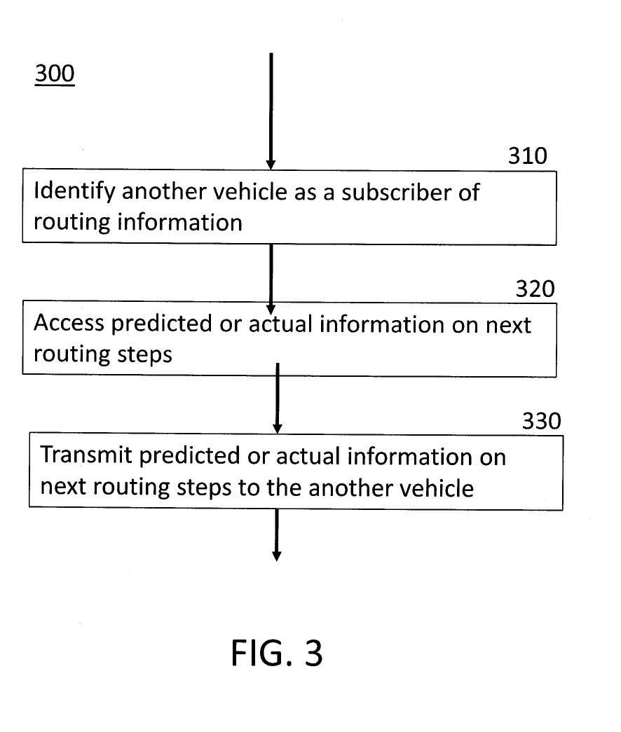

FIG. 3 depicts an illustrative process for providing routing information of one vehicle to another vehicle in accordance with an embodiment. In arrangements, the process 300 is executed by navigation software and an associated communications system present on a smartphone, tablet, factory-installed navigation system, third-party mounted navigation system, laptop, portable digital assistant (PDA), or smart watch device. For illustrative purposes, it will be assumed in the following description that navigation software and the associated communications system performs the process 300. Further, the navigation software and the associated communications system will be referred to as a “navigation system” hereinafter.

At 310, the navigation system of a first vehicle identifies a second vehicle as a “subscriber” to routing information of the first vehicle. The identification may be performed according to several different techniques. In arrangements, the first vehicle identifies the second vehicle based on a RFID, near-field communications, or another direct communications link between the first vehicle and the second vehicle. In arrangements, the first vehicle and the second vehicle both subscribe to a common cloud-based service and the service identifies the second vehicle to the first vehicle. For example, in arrangements, the service tracks the location of both the first vehicle and second vehicle and, when the first vehicle and the second vehicle are in sufficiently close distance, the service identifies the second vehicle to the first vehicle. In arrangements, the second vehicle identifies itself to the first vehicle by transmitting a broadcast identification message. The broadcast may occur periodically at regular intervals or be initiated manually by the driver of the second vehicle, e.g., using a “push to talk” type feature.

At 320, the first vehicle accesses predicted or actual information describing its own next navigational routing steps. This information is generally obtained from one (or more) of the following sources:

(1) In-progress navigation. In some arrangements, if the first vehicle has an active navigation-session enabled, then the first vehicle accesses the next step or set of steps in the navigation route as the predicted information.

(2) Navigation history. In some arrangements, the navigation system of the first vehicle predicts the next step or steps in the navigational route of the driver of the first vehicle based on a past history of navigational routes traveled by the first driver of the first vehicle (“first driver”). In some arrangements, the navigation system provides particularly accurate results by distinguishing between the various drivers of the first vehicle over time, e.g., by requiring that each driver sign-in before driving the first vehicle.

(3) Explicit user commands. In some arrangements, the navigation system of the first vehicle receives explicit input from the first driver specifying the first driver's next step or steps in their planned driving route. The first driver may enter this information on a keypad or touchscreen-type device or speak this information audibly so that it is recognized by a voice recognition subsystem of the navigational system.

The navigational system may use two or more of the above techniques to derive the predicted or actual information. Navigational “steps” include changes in the driving pattern of the first vehicle that may appear sudden to a driver of the second vehicle (“second driver”) if the second driver is not aware of the change ahead of time. Navigational steps include events of rapid deceleration, abrupt left or right turns, frequent lane changes, or lane bypass maneuvers. As would be understood by one of ordinary skill, based on the disclosure and teachings herein, the navigational history and prediction functions may be performed either locally by the navigation system or at a remote server, with the history and prediction information communicated to and from the navigation system via a cellular connection, WiFi connection, or any other suitable type of wireless connection.

At 330, the first vehicle transmits the predicted or actual information on next routing steps accessed at 320 to the second vehicle. This transmission may be either direct from the first vehicle to the second vehicle (e.g., using a LTE direction or other mobile-to-mobile or vehicle-to-vehicle communications protocol) or indirect (e.g., relying on a cellular infrastructure as an intermediary between the first and second vehicles). Once the second vehicle receives the predicted or actual information from the first vehicle, it presents it to the second driver so that the second driver can take appropriate action to drive more safely and reduce a potential for an accident. In arrangements, a navigation system in the second vehicle displays an alert or message on a screen identifying the first vehicle to the second diver and/or providing an indication of the nature of the next navigational step to be performed by the first vehicle to the second driver. Additionally or alternatively, a navigation system of the second vehicle may cause an audible message to be presented to the second driver. The audible message identifies the first vehicle and/or provides an indication of the nature of the next navigational step to be performed by the first vehicle.

Bypassing another vehicle on a road is one of the most dangerous maneuvers performed by average and (otherwise) cautious drivers. Particularly when performed at high-speed and on a two-lane road with minimal shoulder space, such bypass procedures are fraught with danger. In a bypass maneuver, there are many potential sources of accident. For example, a driver of the passing vehicle may fail to properly estimate the speed and time-to-encounter of an oncoming vehicle, a driver of the vehicle being passed may subconsciously speed-up thereby extending the length of time required for the bypass procedure, or the passing vehicle may stall during the rapid acceleration process.

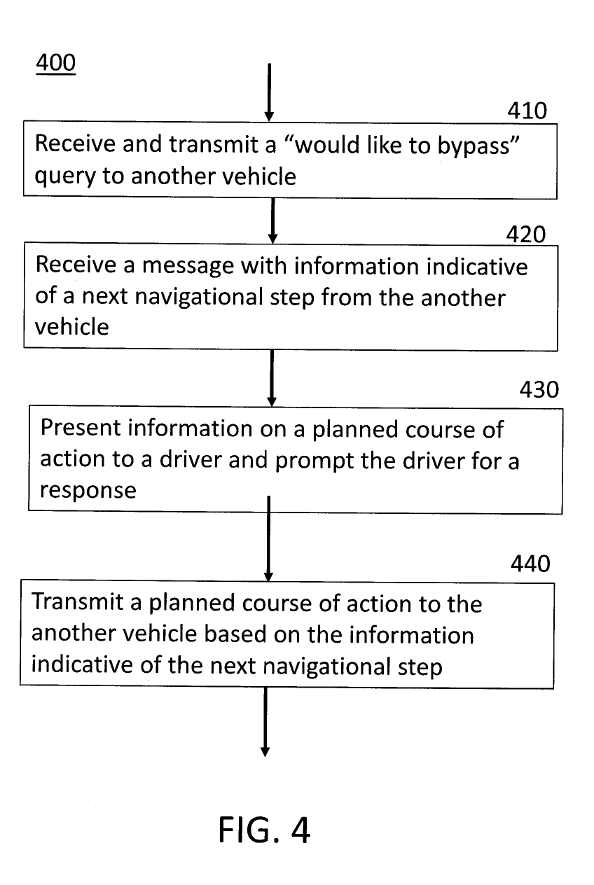

Accordingly, FIG. 4 depicts an illustrative process for coordinating a bypass of a vehicle in accordance with an embodiment. In arrangements, the process 400 is executed by navigation software and an associated communications system present on a smartphone, tablet, factory-installed navigation system, third-party mounted navigation system, laptop, PDA, or smart watch device. For illustrative purposes, it will be assumed in the following description that navigation software and the associated communications system performs the process 400. Further, the navigation software and the associated communications system will be referred to as a “navigation system” hereinafter.

At 410, the navigation system of a first vehicle receives an indication that its driver would like to bypass a vehicle ahead of it. The navigation system can receive this message based on user input (e.g., via a touchscreen or physical keypad input) or by audible command. Upon receiving the message, the first vehicle transmits a “would like to bypass” query (i.e., message) to the second vehicle. In various implementations, the basis for establishing a line of communications between the first vehicle and second vehicle is done according to any of the scenarios described in relation to process 300 of FIG. 3 (above).

Upon receiving the query, a navigation system of the second vehicle accesses information on a next navigational step to be performed by the second vehicle (e.g., a distance until a next turn off the current road the second vehicle is driving on). This information may be accessed from navigation directions of the second vehicle if the navigation system is actively providing such directions or from historical records of navigation routes followed the second driver. Further, this information may be accessed locally from information stored by the navigation system of the second vehicle or from a cloud-based database that the navigation systems of the first and second vehicle are able to communicate with. The navigation system of the second vehicle transmits the information on the next navigational step to the first vehicle. At 420, the first vehicle receives a message with the information indicative of the next navigational step from the second vehicle.

At 430, the navigation system of the first vehicle presents the information on the next navigational step to its driver. This information may be presented via a display screen and/or audible message and informs the first of whether the second vehicle will soon be turning off of the current road or taking another action that will make a lane bypass procedure unnecessary and therefore save the first driver the risk of an accident. For example, the navigation system may present a graphic overlay depicting the second vehicle, a turn that the second vehicle will likely take, and an estimated time until the second vehicle takes the turn. At 430, the navigation system further prompts the first driver for his or her planned course of action. For example, in arrangements, the prompt may state “Will you perform a bypass procedure?” and allow the first driver to provide a “Yes” or “No” response. The navigation system of the first vehicle receives the “Yes” or “No” response from its driver.

At 440, the navigation system of the first vehicle transmits information on the planned course of action of the first vehicle (i.e., whether a bypass procedure is being commenced) to the navigation system of the second vehicle. If a bypass procedure is to be commenced by the first vehicle, the second driver is provided with a suitable warning or alert message at 440. This allows the second driver time to prepare for the bypass procedure. For example, the second driver will know to slow down or at least maintain steady speed in order to reduce any chance of an accident during the bypass procedure.

Consider now a scenario in which a second vehicle desires to follow a first vehicle. For example, a driver of a second vehicle may be unfamiliar with roads in any area and so the driver of the first and second vehicles may agree that the second vehicle will follow the first vehicle to a destination. In an arrangement, a navigation system of the first vehicle initiates continuous transmission of a “follow me” signal that is received by the second vehicle. This makes it easy for a navigation system of the second vehicle to identify and follow the first vehicle. The follow me signal also provides various additional information and warnings (e.g., advance notice of lane changes and left or right turns to be performed by the first vehicle) to help the second vehicle navigate even when the driver of the second vehicle “loses sight” of the first vehicle. In arrangements, the second vehicle receives navigation instructions that allow it to follow the first vehicle using a standard GPS interface on a display. Thus, the follow-me experience is presented in a manner that a driver of the second vehicle is already used to from existing GPS-based navigation systems.

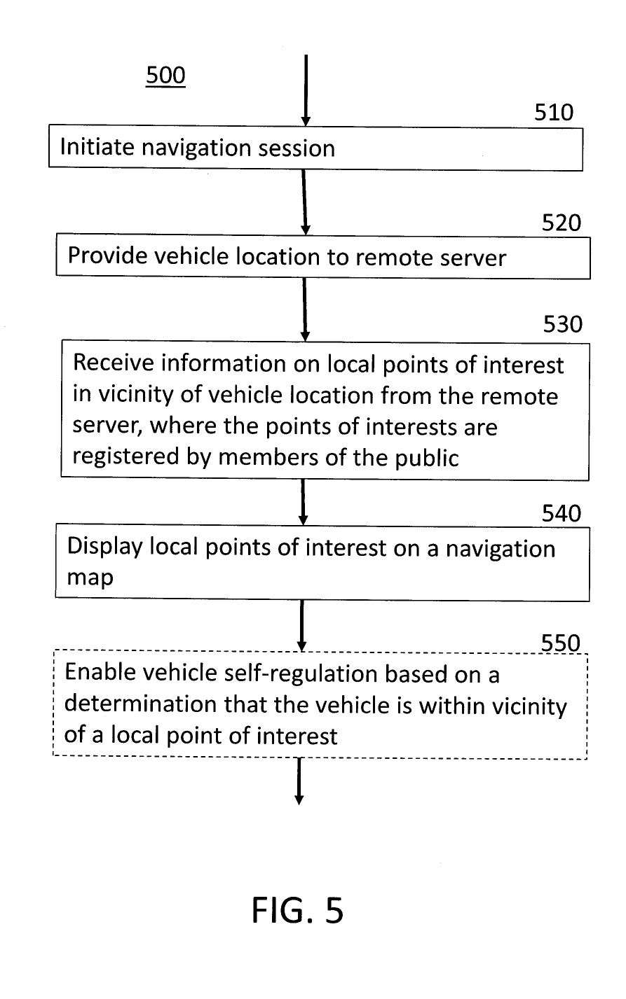

FIG. 5 depicts an illustrative remote server-based process for displaying local points of interest on a navigation map in accordance with an embodiment. In arrangements, the process 500 is executed by navigation software and an associated communications system present on a smartphone, tablet, factory-installed navigation system, third-party mounted navigation system, laptop, portable digital assistant (PDA), or smart watch device. For illustrative purposes, it will be assumed in the following description that navigation software and the associated communications system performs the process 500. Further, the navigation software and the associated communications system will be referred to as a “navigation system” hereinafter.

At 510, a driver of a vehicle initiates a navigation session. The session may be initiated when the driver starts his or her vehicle or when the driver first “turns on” the navigation system of his or her car. At 520, the navigation system provides a location of the vehicle to a remote server. The location may be GPS coordinates of the vehicle. In arrangements, the navigation system transmits this information to the remote server via a cellular network. In arrangements, the navigation system transmits the information to the remote server via WiFi, mobile-to-mobile, or vehicle-to-vehicle wireless connection.

In response to the received GPS coordinates, the remote server queries a database to determine if there exist any points of interest in vicinity of the vehicle's location. If such points of interest exist, then information identifying these points of interest is transmitted to the vehicle (the transmission to the vehicle may occur using the same network and communications technology that is used to provide the vehicle's location to the remote server). Accordingly, at 530, the vehicle receives information on the local points of interest from the remote server.

The points of interest received at 530 are crowd-sourced. In particular, members of the public (“community members”) not employed or necessarily in contract with the vehicle maker, the driver, and the navigation system maker, are able to use a website to enter location point of interest information. To do so, the community members may enter GPS coordinates or a street addresses of the point of interest and times during which the points of interest are active (e.g., a yard sale may only be active for one afternoon while a bake sale may be active every Saturday afternoon for one month straight).

In an arrangement, integrity of the crowd-sourced local points of interest provided by the community members is ensured through one or more of the following techniques. In some arrangements, “contributors” to the community database develop “feedback” or “reputation scores” over time based on their contributions. These scores are assessed by drivers who can rate the accuracy of the information provided by that contributor. In arrangements, only registered and/or paid community members of the website are allowed to contribute local points of interest. In an arrangement, contributions of some or call community members to the database do not become accessible on navigation maps until the information has been reviewed and “verified” by the navigation software entity or organization or a third-party organization or entity. In some arrangements, community members have to pay a fee to register a local point of interest with the database.

Unlike at least some traditional GPS systems, current database data is routinely downloaded to navigation systems via cellular connection or some other connection. Thus, once approved or otherwise “ready,” a local point of interest appears on a navigation map within hours or within a day.

At 540, the information on local points of interest received at 530 is superimposed and displayed on what is otherwise a traditional GPS navigation map. In arrangements, the user of the navigation system is able to toggle the local points of interest on or off through a software option. In arrangements, the user of the navigation system is able to toggle which local points of interest appear on the navigation map based on reputation scores of community members who contributed the local point of interest and/or other driver feedback on the accuracy and usefulness of the contribution. For example, the user may decide to only display local points of interest that were contributed by community members having a “four star” or “five star” rating.

Certain types of local points of interest have the potential to influence how a driver controls (or should control) his or her vehicle in vicinity of that local point of interest. For example, using the database above, persons who are deaf or blind (or their parents or guardians) may elect to register a 3×3 block radius of where the child typically plays (and the times of the week that the child typically plays). As another example, a neighborhood watch group may wish to register locations of speed bumps, particularly those that are hard to see at night, to increase compliance by drivers who drive through the neighborhood.

As an optional feature, points of interest such as these that have the potential to influence how a driver controls his or vehicle may generate alerts in the driver's car when the driver is in the vicinity. When a driver sees an alert for a speed bump display on their navigation screen at night, for example, he or she knows to slow down their car ahead of the speed bump. As optional functionality, at 550, a car manufacturer may install required or optional control equipment. The equipment is able to self-regulate (i.e., auto-drive) based on a determination that the vehicle is in vicinity of certain local points of interest. For example, the vehicle may auto-brake in response to approaching a registered stop sign. Additionally, in cases that don't involve the auto-drive feature, violations of government regulations may be reported back to the manufacturer or a third party service such as a government monitoring agency.

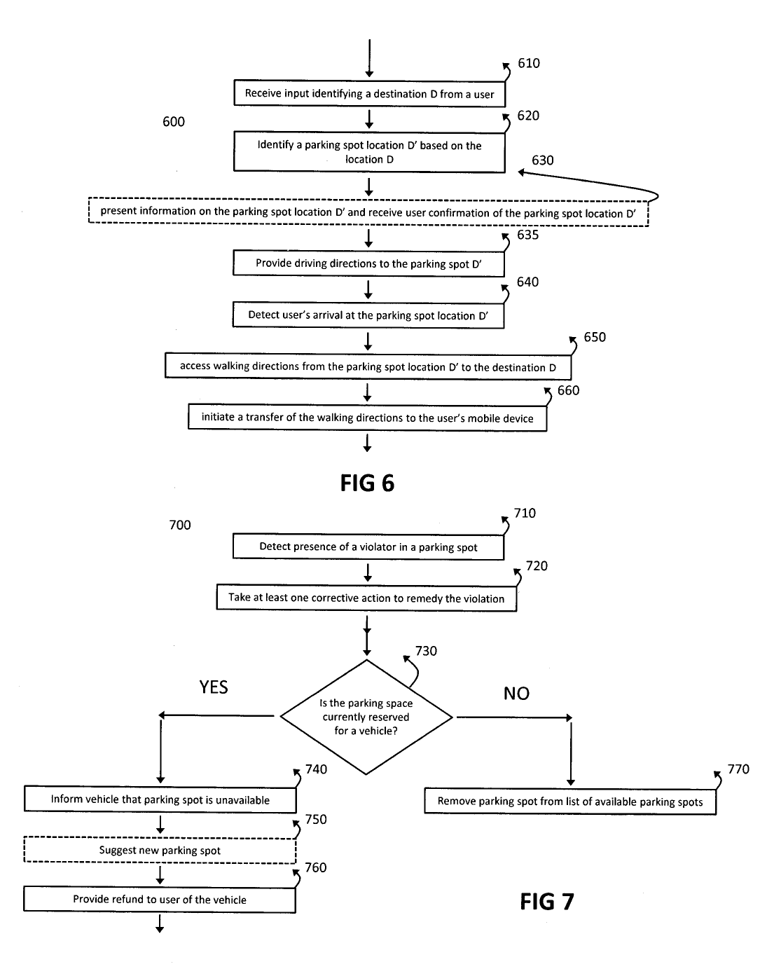

FIG. 6 depicts an illustrative process for guiding a user to a parking space and to a destination in accordance with an embodiment. In some arrangements, certain portions of the process 600 are executed by a navigation system located in a user's car, while certain portions of the process 600 are executed by software executing on the user's mobile device. At 610, an input is received from a user specifying an intended destination D for the user. The destination D is a place that the user ultimately desires to attend (e.g., a museum, sports stadium, concert hall, or restaurant). In one arrangement, the user enters this information via a navigation touchscreen or control knobs installed as part of a navigation system in the user's car. In another arrangement, the user enters this information into a mobile application running on the user's mobile device and information identifying the user-entered destination D is then transferred from the user's mobile device to the navigation software.

At 620, the navigation software queries a database that includes information on “available” parking spaces and identifies a potential parking space location D′, where the user can park his or her vehicle. Identification of the parking space D′ is based at least in part on the location D as it is generally desirable to provide a parking space location to the user that is not too far away from the location of the intended destination D. In some arrangements, “available” parking spaces include parking spaces that are currently unoccupied and/or parking spaces that are expected to be unoccupied at a time that the user arrives at the destination D′ (e.g., based on predefined schedule information, statistical information, or any other suitable source).

In some arrangements, the parking spot database includes parking spots owned; operated, and/or maintained by a company that is either the same company that provides aspects of the navigation system and mobile device software or that is in contract with the same company that provides aspects of the navigation system and the mobile device software. These aspects will be described further else in this disclosure.

At 630, which is an optional feature of the process 600, information related to the potential parking space D′ is presented to the user. The information is presented on a display screen of the navigation system and/or on the user's mobile device. As a further aspect of this feature, a user is prompted to confirm their acceptance of the potential parking D′ and the confirmation is received. If, on the other hand, the user does not confirm their acceptance of the potential parking D′, another suitable potential parking space may be presented to the user. If the optional functionality described at 630 is not implemented in the process 600, then the system displays information related to the potential parking space D′ on the screen and automatically assumes that the user has accepted the potential parking space D′ unless the system receives explicit information from the user declining acceptance of the parking space D′.

Whether or not explicit user confirmation is required, the information provided to the user on the parking space D′ may include one or more of (6) an address of the potential parking space D′, (7) a cost to the user to park in the potential parking space D′, (3) an estimated time to walk from the potential parking space D′ to the destination D, (4) expected weather conditions in the general area of the parking space D′ and the destination D′, and/or any other suitable.

The parking space D′ need not be reserved at the same time as or even shortly after the time that the user enters driving directions at 660. Rather, the navigation system may wait until the user is sufficiently close to the destination D to perform a search of candidate parking spaces that are generally in the vicinity of the destination D. In general, the parking space D′ is chosen based on one or more of a “tier” of service selected by the user, closeness to the destination D, suitability of walking paths from the parking space D′ to the destination D.

At 635, the navigation system presents the user with driving directions to the parking spot D′. In some arrangements, the navigation system started by providing driving directions to the destination D and so switches modes at 630 to provided driving directions to the parking spot D′ instead. The user is then routed to the destination D′ through automated directions according to the navigation system's normal features.

At 640, the navigation system detects when the user arrives at the parking spot D′ through any suitable method, e.g., based on GPS coordinates, detecting that the user's engine has been turned off, or a combination of these or other factors. At 650, the navigation system access walking directions from the parking spot location D′ to the destination D. On one arrangement, the navigation system transmits data identifying the parking spot location D′ and the destination D over a network to a server and receives back information identifying the walking directions. In one implementation, the navigation system transmits a wireless (e.g., LTE) signal to a cellular base station, where the signal indicates that the user's vehicle has arrived at the destination D′. This signal is routed to a server owned and/or operated by the navigation service provider. The server then generates or identifies walking directions from the destination D′ to the destination D and provides these directions to the user's mobile phone via a cellular communications path.

At 660, the navigation system, detecting that a user has arrived at the parking spot D′, initiates a network based transfer of directions from the navigation system to the user's mobile device, which may be a cellular phone, tablet computer, laptop, personal digital assistant (PDA), or any other suitable device. Specifically, walking directions from the parking space D′ to the user's desired destination D are preloaded on the user's mobile device. In an arrangement, this transfer of information is initiated via cellular or other wide range wireless signals

FIG. 7 depicts an illustrative process for identifying and handling parking space violations in accordance with an embodiment. At 700, the presence of a violator in a parking space is detected. The violator may be detected using any suitable technique. For example, in one arrangement, cars registered with the management company are assigned and provided RFID tags. Alternatively, RFID tags may be embedded in cars during assembly. In either case, if a car parks in a spot without providing a registered RFID-tag, the car is identified as a violator. In one arrangement, weight sensors may be embedded in the pavement underneath a parking spot to register the presence of a car. When the weight sensors are triggered, an RFID check is performed. In another arrangement, violators as well as open parking spaces are detected using camera surveillance and image recognition techniques. In one implementation, cars subscribing to the service use car-mounted cameras to check the status of parking spaces as they drive by those spots (whether they are currently looking for parking or not) and report back the status of those spots via a wireless network connection to the service provider. The service provider receives updates and knows the current status of its parking spaces, and is able to detect the presence of any violators through any suitable combination of one or more of these techniques.

At 720, at least one corrective action is taken to begin a process of remedying the violation. In particular, when a violator is identified, the management company may engage in one or more activities. In some arrangements, the parking management company issues tickets directly to violators or provides information identifying the violator to a government agency so that tickets may be issued. This is particularly the case when the parking management company manages parking spaces on behalf of the city.

At 730, it is determined if the parking space in which a violator was identified is currently reserved for use by another vehicle. If not, then the process 700 proceeds to 720, where the parking spot in which the violator was detected at 760 is removed from a list of “available” parking spaces in the management company's database (the space will again be marked as available once the management company identifies that the violator has been removed from the parking space). On the other hand, if it is determined at the at 730, that the parking space in which a violator was identified is currently reserved for use by another vehicle, then the process 700 proceeds to 740.

At 740, the management company informs the vehicle for which the parking spot was properly reserved that the parking has become unavailable. This information is provided to a driver of the vehicle on their navigational display and/or on a display of their mobile phone. At 750, which describes optional functionality of the process 700, the vehicle management company suggests a new parking spot to the driver of the vehicle. In arrangements, this new parking spot is determined and presented to the user using a technique similar or identical to that described in relation to 620 and 630 of the process 600 (FIG. 6). In arrangements, the vehicle is rerouted to the new parking spot.

At 760, the management company issues a full or partial refund to the vehicle A for the misunderstanding and inconvenience. In arrangements, the refund is in the form of an electronic credit to the driver's bank account.

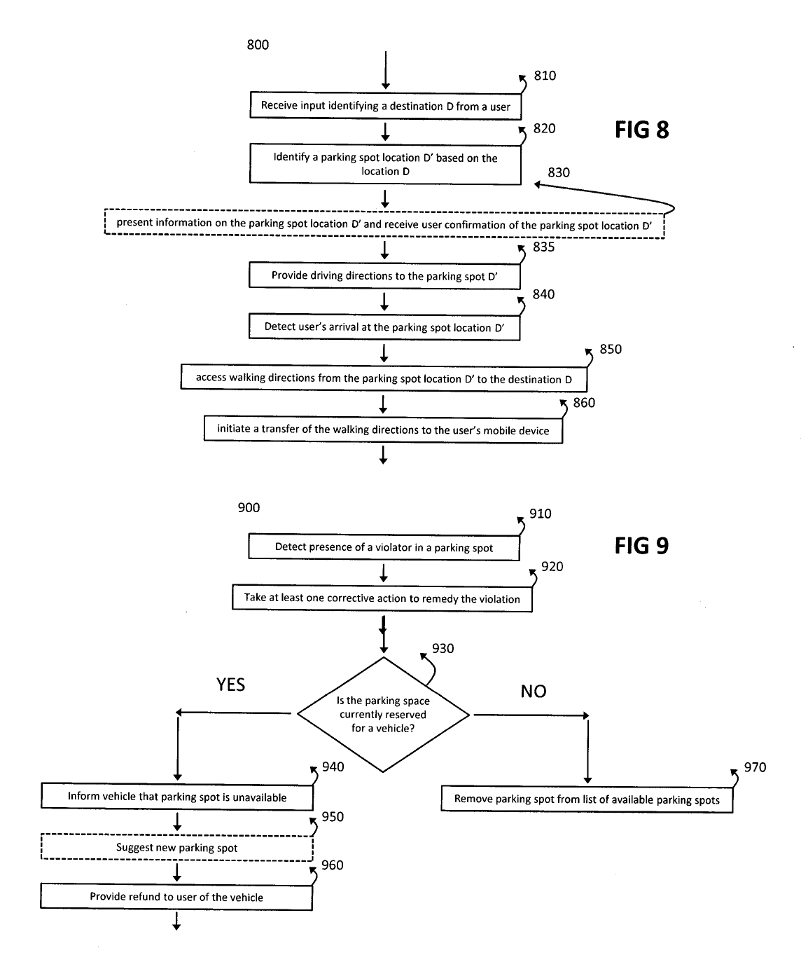

FIG. 8 depicts an illustrative process for guiding a user to a parking space and to a destination in accordance with an embodiment. In some arrangements, certain portions of the process 800 are executed by a navigation system located in a user's car, while certain portions of the process 800 are executed by software executing on the user's mobile device. At 810, an input is received from a user specifying an intended destination D for the user. The destination D is a place that the user ultimately desires to attend (e.g., a museum, sports stadium, concert hall, or restaurant). In one arrangement, the user enters this information via a navigation touchscreen or control knobs installed as part of a navigation system in the user's car. In another arrangement, the user enters this information into a mobile application running on the user's mobile device and information identifying the user-entered destination D is then transferred from the user's mobile device to the navigation software.

At 820, the navigation software queries a database that includes information on “available” parking spaces and identifies a potential parking space location D′, where the user can park his or her vehicle. Identification of the parking space D′ is based at least in part on the location D as it is generally desirable to provide a parking space location to the user that is not too far away from the location of the intended destination D. In some arrangements, “available” parking spaces include parking spaces that are currently unoccupied and/or parking spaces that are expected to be unoccupied at a time that the user arrives at the destination D′ (e.g., based on predefined schedule information, statistical information, or any other suitable source).

At 830, which is an optional feature of the process 800, information related to the potential parking space D′ is presented to the user. The information is presented on a display screen of the navigation system and/or on the user's mobile device. As a further aspect of this feature, a user is prompted to confirm their acceptance of the potential parking D′ and the confirmation is received. If, on the other hand, the user does not confirm their acceptance of the potential parking D′, another suitable potential parking space may be presented to the user. If the optional functionality described at 830 is not implemented in the process 800, then the system displays information related to the potential parking space D′ on the screen and automatically assumes that the user has accepted the potential parking space D′ unless the system receives explicit information from the user declining acceptance of the parking space D′.

Whether or not explicit user confirmation is required, the information provided to the user on the parking space D′ may include one or more of (8) an address of the potential parking space D′, (9) a cost to the user to park in the potential parking space D′, (3) an estimated time to walk from the potential parking space D′ to the destination D, (4) expected weather conditions in the general area of the parking space D′ and the destination D′, and/or any other suitable.

The parking space D′ need not be reserved at the same time as or even shortly after the time that the user enters driving directions at 880. Rather, the navigation system may wait until the user is sufficiently close to the destination D to perform a search of candidate parking spaces that are generally in the vicinity of the destination D. In general, the parking space D′ is chosen based on one or more of a “tier” of service selected by the user, closeness to the destination D, suitability of walking paths from the parking space D′ to the destination D.

At 835, the navigation system presents the user with driving directions to the parking spot D′. In some arrangements, the navigation system started by providing driving directions to the destination D and so switches modes at 830 to provided driving directions to the parking spot D′ instead. The user is then routed to the destination D′ through automated directions according to the navigation system's normal features.

At 840, the navigation system detects when the user arrives at the parking spot D′ through any suitable method, e.g., based on GPS coordinates, detecting that the user's engine has been turned off, or a combination of these or other factors. At 850, the navigation system access walking directions from the parking spot location D′ to the destination D. On one arrangement, the navigation system transmits data identifying the parking spot location D′ and the destination D over a network to a server and receives back information identifying the walking directions. In one implementation, the navigation system transmits a wireless (e.g., LTE) signal to a cellular base station, where the signal indicates that the user's vehicle has arrived at the destination D′. This signal is routed to a server owned and/or operated by the navigation service provider. The server then generates or identifies walking directions from the destination D′ to the destination D and provides these directions to the user's mobile phone via a cellular communications path.

At 860, the navigation system, detecting that a user has arrived at the parking spot D′, initiates a network based transfer of directions from the navigation system to the user's mobile device, which may be a cellular phone, tablet computer, laptop, personal digital assistant (PDA), or any other suitable device. Specifically, walking directions from the parking space D′ to the user's desired destination D are preloaded on the user's mobile device. In an arrangement, this transfer of information is initiated via cellular or other wide range wireless signals

In general, a company may own, operate, and/or maintain a set of parking spaces that are used as part of the reservation system described above. In one embodiment, the company offers the following types of parking spaces:

(1) Privately-owned spaces. Individual owners of parking spaces (e.g., apartment side spaces initially reserved to apartment owners) can register their parking spaces with the management company for user during specified times. The management company effectively “rents” these parking spaces during the specified times;
(2) Exclusively-owned spaces. The management company may purchase private parking spaces, e.g., to ensure that a certain baseline level of spaces are always available; and
(3) Authority-granted spaces. The management company may be entrusted to manage certain parking spaces, e.g., by local municipalities, city, state, and/or federal governments that do not want to deal with the specifics of managing these spaces on their own. In some cases, the management company may be the exclusive operator of these spaces.

Thus, the management company effectively has control over a wide range of parking spaces in many geographically dispersed parts of a city or other geographic area (in one arrangement, these spots and their occupancy status can be viewed in more or less real-time via maps provided on the mobile device and navigation system). One function provided by the management company, particularly when it has exclusive control over parking spaces, is detecting violators, i.e., vehicles or other parties that park in space without having been authorized by the management company to do so via the navigation or mobile application software.

FIG. 9 depicts an illustrative process for identifying and handling parking space violations in accordance with an embodiment. At 900, the presence of a violator in a parking space is detected. The violator may be detected using any suitable technique. For example, in one arrangement, cars registered with the management company are assigned and provided RFID tags. Alternatively, RFID tags may be embedded in cars during assembly. In either case, if a car parks in a spot without providing a registered RFID-tag, the car is identified as a violator. In one arrangement, weight sensors may be embedded in the pavement underneath a parking spot to register the presence of a car. When the weight sensors are triggered, an RFID check is performed. In another arrangement, violators as well as open parking spaces are detected using camera surveillance and image recognition techniques. In one implementation, cars subscribing to the service use car-mounted cameras to check the status of parking spaces as they drive by those spots (whether they are currently looking for parking or not) and report back the status of those spots via a wireless network connection to the service provider. The service provider receives updates and knows the current status of its parking spaces, and is able to detect the presence of any violators through any suitable combination of one or more of these techniques.

At 920, at least one corrective action is taken to begin a process of remedying the violation. In particular, when a violator is identified, the management company may engage in one or more activities. In some arrangements, the parking management company issues tickets directly to violators or provides information identifying the violator to a government agency so that tickets may be issued. This is particularly the case when the parking management company manages parking spaces on behalf of the city.

At 930, it is determined if the parking space in which a violator was identified is currently reserved for use by another vehicle. If not, then the process 900 proceeds to 970, where the parking spot in which the violator was detected at 980 is removed from a list of “available” parking spaces in the management company's database (the space will again be marked as available once the management company identifies that the violator has been removed from the parking space). On the other hand, if it is determined at the at 930, that the parking space in which a violator was identified is currently reserved for use by another vehicle, then the process 900 proceeds to 940.

At 940, the management company informs the vehicle for which the parking spot was properly reserved that the parking has become unavailable. This information is provided to a driver of the vehicle on their navigational display and/or on a display of their mobile phone. At 950, which describes optional functionality of the process 900, the vehicle management company suggests a new parking spot to the driver of the vehicle. In arrangements, this new parking spot is determined and presented to the user using a technique similar or identical to that described in relation to 820 and 830 of the process 800 (FIG. 8). In arrangements, the vehicle is rerouted to the new parking spot.

At 950, the management company issues a full or partial refund to the vehicle A for the misunderstanding and inconvenience. In arrangements, the refund is in the form of an electronic credit to the driver's bank account.

Hereinafter, embodiments of the presently-disclosed techniques for selecting and playing electronic engine sounds, e.g., as a pedestrian safety measure, are described with reference to the accompanying drawings. Like reference numerals may refer to similar or identical elements throughout the description of the figures.

The techniques described herein are preferably, though not mandatorily, embodied on a “smart vehicle.” A smart vehicle is a vehicle that is generally capable of sensing aspects of its environment and adapting some aspect of its functioning based on the sensed parameters in a way that vehicles have not traditionally been capable until the last several years. A typical smart vehicle may embody one or several of the following characteristics.

First, a smart vehicle may be an electronic vehicle, meaning a vehicle with an electronic engine and/or battery. A smart vehicle may have a system of speakers mounted inside and outside the vehicle (the speakers mounted outside the vehicle are typically weather ruggedized). Further, a smart vehicle may have a computer system connected to an electronic battery, a speaker system, and capable of transmitting and receiving data from an external communications network. For example, the smart vehicle may have a cellular transmitter capable of communicating with a cellular network (and hence, the Internet) and/or vehicle-to-vehicle communications circuitry. To detect parameters of its environment, a smart vehicle may have environmental sensing equipment including a positioning system, speedometer, accelerometer, vehicle type identifier, and one or more internally or externally mounted video cameras.

In arrangements, the process 1000 is executed by a computer system and associated communications system (hereinafter, “computer system”) in the smart vehicle. For illustrative purposes, it will be assumed in the following description that the computer system performs most or all of the functionality described in relation to the process 1000.

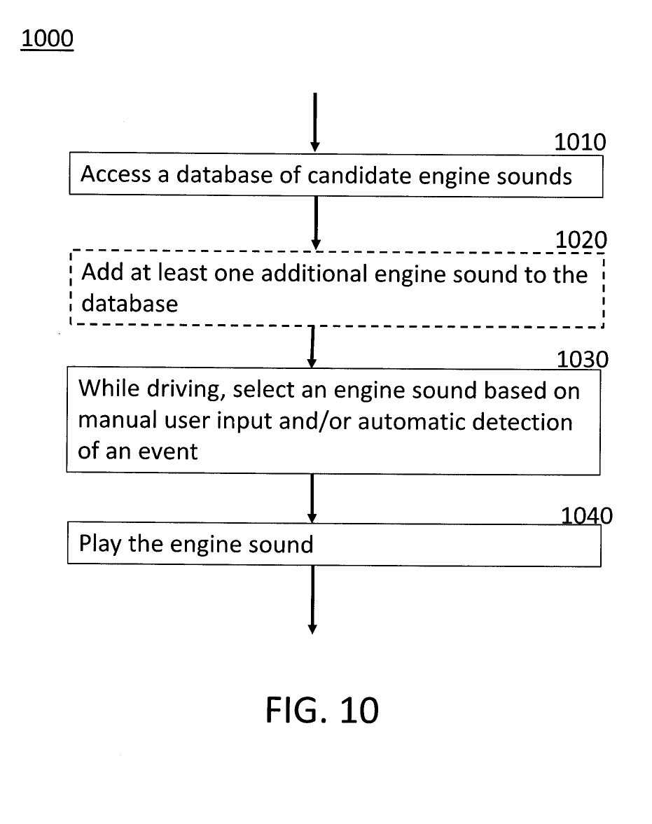

FIG. 10 depicts an illustrative process for selecting and playing electronic engine sounds using a smart vehicle, e.g., as a pedestrian safety measure, in accordance with an embodiment. At 1011, a database of candidate engine sounds is accessed from a database. The database may include engine sounds pre-installed at a factory that built the smart vehicle and/or sounds that have been added to the database since the owner has had possession of the smart vehicle. While virtually any type of sound that can be recorded and played back may be used as an engine sound, a typical class of engine sounds are those that are designed to mimic normal environmental sounds. For example, included in the database 1010 may be engine sounds that mimic a traditional vehicle of the same size and weight operating at different speeds (e.g., 10 miles per hour (mph), 30 mph, and 50 mph) and on different surfaces (e.g., highway, gravel roads, and dirt roads). The database of engine sounds may either be stored locally on a memory residing in the smart vehicle or the database may be stored in a cloud server and streamed or download and played on use.

Another class of available sounds are not engine sounds, but rather, “vanity” sounds. In particular, a user may customize sounds associated with routing car functions such as starting the ignition, opening a door, driving while a seatbelt is unfastened, opening a trunk, opening a engine hood, honking a horn, and the like.

At the optional 1020, at least on additional engine sound is added to the database. According to various arrangements, there are at least three ways in which additional engine sounds can be added to a database. In some arrangements, an owner of the vehicle may have new sounds added (e.g., via a flash memory) link at a vehicle dealership or independent repair center. In some arrangements, the manufacturer makes new engine sounds available and automatically pushes them to the database on behalf of the user (either for free or through a paid subscription model). In some arrangements, the user access a iTunes-like store, either from a computer or a built-in display mounted in the car, where he or she may browse, preview, and download new engine sounds (for free or at a cost). In general, engine sounds may be produced by a car manufacturer or by independent third parties. These third parties may have a contract with the car manufacturer to produce new sounds and/or may produce new sounds and sell them for a profit via the iTunes-like downloadable engine sound store.

At 1030, while driving, an engine sound from the database is selected based on manual user input and/or an automatic detection of an event. In some arrangements, a user may manually turn on “automatic engine sounds” via a software menu. Then, with this feature enabled, the car may play a suitable engine sound at 1040 to mimic what a traditional vehicle engine would sound like. The automatic selection at 1030 may be based on an algorithm that takes as inputs data collected from various “smart” features of the smart vehicle and plays an engine sound. Inputs may include (i) a speed that the vehicle is travelling at, (ii) the degree of urbanization through which the vehicle is travelling, (iii) weather conditions, (iv) a degree to which the gas pedal of the smart vehicle is depressed, (v) whether a presence of any pedestrian has been detected by the cameras and or image recognition systems of the smart vehicle.

A vehicle that generally played engine sounds all of the time or much of the time would potentially create unnecessary noise pollution. Therefore, in some arrangements, the smart vehicle uses two features reduce noise pollution when engine sounds are likely not needed to ensure the safety of pedestrians and other standers-by. First, in some arrangements, the smart vehicle includes a pedestrian recognition system. The system identifies when pedestrians are or are likely to be present based on one or more of image recognition via vehicle-mounted cameras, historical data correlated with the vehicles GPS coordinates, beacon messages, and automated detection of crosswalks. The smart vehicle only enables the playing of engine sounds upon detecting one or more of these “events” has occurred.

To further reduce unnecessary noise pollution, the smart vehicle may directionally play sounds. That is, the vehicle's intelligent systems detect not only the presence or likely presence of pedestrians using any of the techniques described above, but also, determine a relative location of those pedestrians with respect to the smart vehicle's location (e.g., 30 degree northwest and 50 feet away). The loudspeakers of the car then directional play sound in the determined directions and at the minimal reasonable volume that is typically required to get a pedestrian's attention.

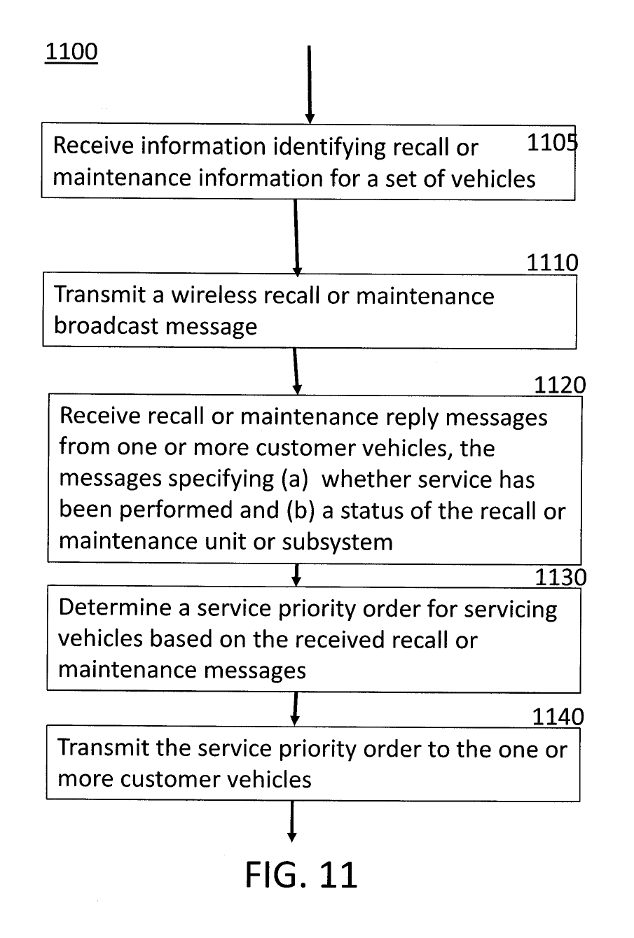

FIG. 11 depicts an illustrative network-based process for collecting vehicle information and transmitting service priority order information to vehicles in accordance with an embodiment. In arrangements, the process 1100 is executed by an authorized vehicle, i.e., a service vehicle owned by a car manufacturer, dealer, or other paid agent that travels roadways and collects and transmits information related to vehicle recalls and maintenance. For clarity of presentation, it will be assumed in the description below that such an authorized vehicle performs the process 1100.

At 1105, the authorized vehicle receives information identifying recall or maintenance information for a set of vehicles. The information may be entered manually into a computing system of the authorized vehicle or the authorized vehicle may regularly download such information from a server using a wired or wireless connection (e.g., a cellular-based connection). At 1110, the authorized vehicle, while driving on public roadways, transmits a wireless recall or maintenance broadcast message. In arrangements, the message includes, in addition to information about the parts or subsystems that are affected by the recall or maintenance, a vehicle mode and year and/or other information in a header that specifically identifies the set of vehicles to which recall or maintenance information applies. The message is able to be read and processed by vehicles to which it applies. While the message may be received by vehicles to which it does not apply, those vehicles disregard the message.

At 1120, the authorized vehicle receives recall or maintenance reply messages from one or more customer vehicles from the set of vehicles to which the recall or maintenance applies. A given reply message corresponds to a given vehicle and, for that vehicle, specifies (a) whether service has been performed on the vehicle to address the recall or maintenance that is the subject of the broadcast message sent at 1110, and (b) a status of the call or maintenance unit or subsystem. As would be understood by one of ordinary skill in the art, based on the teachings and disclosure herein, a car controller may store information on (a) and (b), above. In some arrangements, the authorized vehicle reports information collected on (a) and (b) to the vehicle's manufacturer. The manufacturer can use this crowd-sourced data for any suitable purpose.

As an example, suppose that the broadcast message sent at 1110 relates to a recall for a brake system in 2016 pickup trucks by manufacturer M. In that case, each 2016 pickup truck by manufacturer M that receives the broadcast message replies with a message at 1120 that (a) specifies whether the recall work has been performed on that pickup truck and (b) a status of the brake system on the pickup truck. In some arrangements, the status may be a simple “WORKING PROPERLY” or “NEEDS INSPECTION” message. In some arrangements, the status message may take on a large number of values (e.g., number on a scale from 1 to 100); with larger numbers denote a braking system that is in better condition.

At 1130, the authorized vehicle determines a service priority order for servicing vehicles based on the received recall or maintenance messages. The authorized vehicle may make this determination locally or it may transmit information related to the received recall or maintenance messages to a remote server and receive back the service priority order from the server. The service priority order essentially specifies a number in a queue for each vehicle that transmits a reply recall or maintenance message. In some arrangements, the service priority order is set to ensure that vehicles with the “worst” statuses (i.e., those most in need of recall or maintenance inspection or repair) are prioritized over those vehicles with better statuses. At 1140, the authorized vehicle transmits the service priority order to the one or more customer vehicles that provided reply messages at 1120. In arrangements, the authorized vehicle transmits to each vehicle only its respective service priority order number (for privacy and other reasons).

In an arrangement, some or all of the customer vehicles receiving a recall or maintenance message or transmitting a reply to a recall or maintenance message are automatically turned into agents of the authorized vehicle. As agents, these customer vehicles re-broadcast the recall or maintenance information originally broadcast at 1110 to other vehicles as they travel about their paths. This dynamics thus create a viral effect in which a large number of customer vehicles learn about recall or maintenance information relevant to their cars.

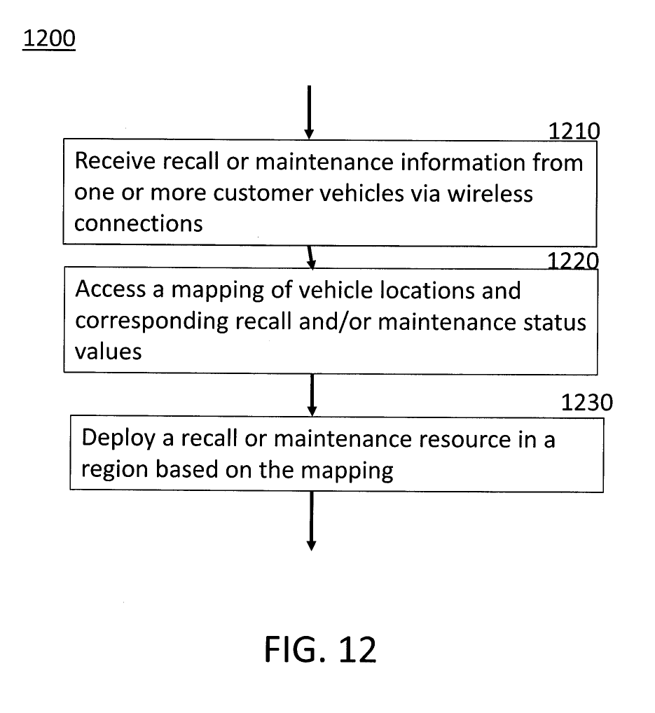

FIG. 12 depicts an illustrative network-based process for deploying vehicle recall or maintenance resources in a geographic region in accordance with an embodiment. In arrangements, the process 200 is executed by a computing system of a vehicle manufacturer (“computing system”). For clarity of presentation, it will be assumed in the description below that such an authorized vehicle performs the process 1200.

At 1210, the computing system receives recall or maintenance information from one or more customer vehicles via a wireless connection. Specifically, the information received from each vehicle may specify (i) whether service has been performed on the vehicle to address the recall or maintenance that is the subject a particular manufacturer initiative or maintenance program and (ii) a status of the maintenance unit or subsystem of the vehicle that is the subject of the particular manufacturer initiative or maintenance program. As would be understood by one of ordinary skill in the art, based on the teachings and disclosure herein, a car controller may store information on (i) and (ii), above. In arrangements, the computing system may receive this information directly from vehicles. In arrangements, the computing system may receive this information from one or more authorized vehicles, as described in relation to the process 1100 of FIG. 11.

At 1220, the computing system accesses a mapping of vehicle locations and corresponding recall and/or maintenance status values. The computing system may generate this information directly from the data received at 1210 or the computing system may pass the data received at 1210 to another system or third-party service, which then generates the mapping and returns it to the computing system. In arrangements, the mapping depicts vehicle locations on a map and an indication of whether a given type of recall and/or maintenance has been performed on those vehicles.

A human or computer analyzes the mapping accessed at 1220, to determine geographic regions in which a relatively large percentage of eligible vehicles have not had recall or maintenance work performed. Accordingly, at 1230, the manufacturer deploys a recall or maintenance resource in a region based on the mapping. For example, in arrangements, the manufacturer deploys an authorized vehicle in a region in which a relatively large percentage of eligible vehicles have not had recall or maintenance work performed. The authorized vehicle then travels the roads of the region and broadcasts recall or maintenance information for a set of vehicles as described in relation to process 1100 of FIG. 11.

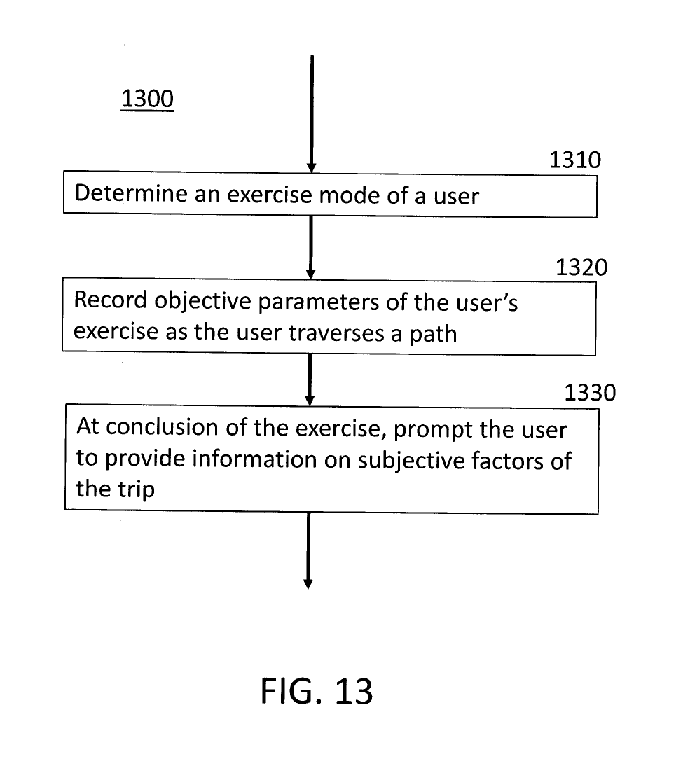

FIG. 13 depicts an illustrative process for crowd-sourcing path data from walkers, runners, swimmers, and/or bikers in accordance with an embodiment. In arrangements, the process 100 is executed by a mobile application running on a user's mobile device, such as on a smartphone, tablet, smart watch, or sports watch.

The process 1300 beings shortly before or during an exercise routine followed by an exerciser. At 1310, an exercise mode that a user intends to engage in or that the user is engaged in is determined. In arrangements, the exercise mode is one of “walking,” “running,” “biking,” or “swimming.” The exercise mode may be determined manually, by prompting the user to enter the nature of their exercise routine, or automatically, by tracking the user's location (e.g., through GPS enabled on their mobile device) over time and making an inference about the type of exercise activity being performed.

In relation to the process 1300, the user may follow an exercise path of their own choosing or they may follow a path recommended to them by software that also executes the process 1300. In either case, at 1320, the process 1300 records “objective” parameters of the user's exercise along the path that the user follows. Objective parameters of the user's exercise are parameters that are relatively easy to measure using automated means and that reflect basic “statistics” of the path and/or the user's biological performance. Objective factors recorded in relation to 1320 may include one or more of a time for the user to complete traversing the path, a heart rate and other physiological parameters of the user while traversing the path, and elevation data (e.g., rates of incline and decline), particularly with respect to the running and biking modes.

At 1330, the process 1300 prompts the user to “evaluate” or “assess” their exercise path according to one or more subjective factors at the conclusion of their exercise along the path. Subjective parameters of the user's exercise are parameters that are not easily measured through automated means and that reflect characteristics that can make a given path seem “new” or “unique” to a regular exerciser. In various arrangements, the user/exerciser is prompted to evaluate or assess their exercise path at 1330 according to one or more of (i) scenic beauty of the path, (ii) a degree of variety in the natural surroundings over the duration of the path, (iii) a presence of wildlife along the path, and (iv) a degree of perceived safety along the path. Further, in some arrangements, the user is prompted to provide this subjective information on a segment-by-segment basis along the path. For example, if a jogger has just completed a jog of five miles along an exercise path, the process 1300 may prompt the user to evaluate the criteria (i) through (iv) on a per-mile basis at 1330. In some arrangements, the user can interface with a map on their mobile device to define and/or select particular segments of their path (after which, they are prompted to evaluate subjective information about each segment of their path as described above).

The subjective and objective assessments of various exercise paths provided by multiple exercisers in relation to their respective exercise paths are uploaded and stored in some form on a server. In arrangements, longer exercise paths are divided into segments and subjective and objective assessments are stored on a per-segment basis. Segments generally correspond to a stretch along a path between two “forks in the road,” where an exerciser is able to choose a different course for their path. For example, in the case of running along public streets, a segment corresponds to a stretch of road located between two intersections, since runners who start on public streets tend to stay on public streets for the majority of their run. From all of the data collected, the server is able to reliably determine a crow-sourced average of the objective and subjective characteristics that should be associated with each path, and, in arrangements, with each segment of each path (provided sufficient crowd-sourced data is available to the server). For example, based on the received crowd-sourced information, software executing on the server may determine that a given segment of a path has a large amount of scenic beauty and varied terrain (i.e., subjective factors) and that it takes an average of 14 minutes to bike the segment (i.e., an objective factor).

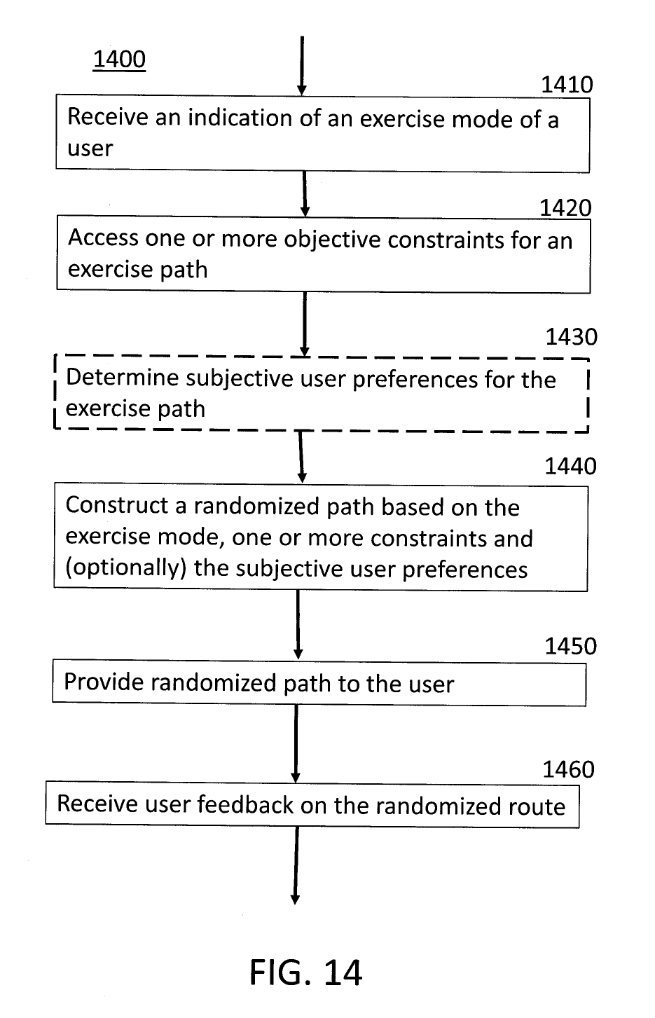

FIG. 14 depicts an illustrative process for recommending a path to a walker, runner, biker, and/or swimmer in accordance with an embodiment. In arrangements, the process 1400 is executed by a mobile application running on a user's mobile device, such as on a smartphone, tablet, smart watch, or sports watch. At 1410, the process 1400 receives an indication of an exercise mode of a user. In arrangements, the exercise mode is one of “walking,” “running,” “biking,” or “swimming,” and is specified by a user via a manual setting on a mobile application based on a type of exercise that the user plans to engage in.

At 1420, the process 1400 accesses one or more objective constraints that the exerciser may have in any exercise path that is to be recommended to the exerciser. Objective parameters of the user's exercise are parameters that are relatively easy to measure using automated means and that reflect basic “statistics” of the path and/or the user's biological performance. Objective factors accessed in relation to 1420 may include one or more of an estimated time for the user to complete exercise along the given path, an expected “toll” on the user in terms of heart rate and other physiological parameters that the user may experience while traversing the path, and elevation data (e.g., rates of incline and decline) along the path. In arrangements, these parameters are entered by a user into a mobile application running on a mobile device.

At the optional 1430, the process 1400 determines subjective user preferences for the to-be-recommended exercise path. In arrangements, the user is prompted to provide a priority-level or preference for one or more of (i) scenic beauty of the path, (ii) a degree of variety in the natural surroundings over the duration of the path, (iii) a presence of wildlife along the path, and (iv) a degree of perceived safety along the path (among other possible criteria).

At 1440, the process 1400 constructs a randomized exercise path based on the exercise mode, the one or more constraints and, if 1430 is performed, the subjective user preferences. In some arrangements, the randomized exercise path is constructed through an optimized “search and add” process in which segments of potential paths are evaluated in a possibly random order for suitability based on the accessed or determined exercise mode, objective factors, and subjective factors. In these arrangements, a segment is included in the recommended exercise path if the segment is determined to contribute to an overall exercise path that matches well with the mode, objective and subjective parameters provided by a user. In implementations, a mobile application running on a mobile device transmits the mode, subjective and objective factors of a user to a server. The server then calculates and returns a randomized recommended path.

At 1450, the randomized exercise path is provided to the user. The recommended path is randomized in the sense that, even for the same “inputs” (i.e., mode, objective factors, and subjective factors), consecutive requests for a path at 1450 are very likely to produce different paths for a user. Further, in some arrangements, a user history of previously partially or fully completed exercise paths is maintained. The randomization algorithm compares candidate recommended paths with those already performed by the user and returns a path that is new or sufficiently new to the user. In this way, the user is presented with “surprise” path that motivates the user to continue to regularly exercise. The surprise path meets certain objective criteria of the user (e.g., an expected time to complete the exercise) and optionally, if 1430 is implemented, is further based on certain subjective preferences of the user. The surprise path is also reasonable given the exercise mode of the user.

At 1460, at the conclusion of the exercise (whether the exercise path was fully completed or not), the user is prompted to provide information on the subjective factors of the exercise path. For example, in arrangements, the user is prompted using a procedure similar or identical to that described at 1330 of the process 1300 (FIG. 13).

Although embodiments have been described in detail with reference to the accompanying drawings for the purpose of illustration and description, it is to be understood that the inventive processes and apparatus are not to be constructed as limited thereby. It will be apparent to those of ordinary skill in the art that various modifications to the foregoing embodiments may be made without departing from the scope of the invention.

1. A method for determining a vehicle-based reputation, the method comprising:
identifying, at a navigation system, a first driver of a remote vehicle;
characterizing driving of the first driver based on the occurrence of one or more events; and
causing transmission of the characterization to a remote server.

2. The method of claim 1, wherein identifying the first driver comprises receiving, from a remote server, a listing of drivers in a vicinity of the navigation system, the listing including information on the first driver.

3. The method of claim 1, wherein characterizing the driving of the first driver comprises monitoring the driver using one or more of a vehicle-mounted camera, a vehicle-mounted radar detector, and a vehicle-mounted sonar detector.

4. The method of claim 3, wherein characterizing the driving of the first driver comprises detecting an occurrence of one or more of an aggressive driving event, a speeding event, and a tailgating event.

5. A method for determining a vehicle condition, the method comprising:
identifying, at a navigation system, a remote vehicle;
characterizing a condition of the remote vehicle based on the occurrence of one or more events; and
causing transmission of the characterization to a remote server.

6. The method of claim 5, wherein identifying the remote vehicle comprises receiving, from a remote server, a listing vehicles in a vicinity of the navigation system, the listing including information on the remote vehicle.

7. The method of claim 5, wherein characterizing the condition of the remote vehicle comprises monitoring the remote vehicle using one or more of a vehicle-mounted camera, a vehicle-mounted radar detector, and a vehicle-mounted sonar detector.

8. The method of claim 7, wherein characterizing the condition of the remote vehicle comprises detecting an occurrence of one or more of a broken light, a tire condition, towing of a heavy load, and unsecured cargo.

9. The method of claim 1, further comprising:
initiating, at a first vehicle, a reputation-based navigation;
causing a display of a roadway and vehicles in vicinity of the first vehicle on a screen; and
causing a display of an indication of reputation for each of the displayed vehicles in vicinity of the first vehicle.

10. The method of claim 9, wherein the indication of reputation for a displayed vehicle is based on at least one of a characterization of the vehicle's condition and a characterization of a driving quality of the vehicle's driver.

11. A method for providing routing information to a vehicle, the method comprising:
identifying, at a first vehicle, a second vehicle, wherein the identification is based on a proximity of second vehicle and the first vehicle;
accessing, at the first vehicle, predicted or actual information on a next navigational routing step associated with the second vehicle;
causing a display of the predicted or actual information on a screen.

12. The method of claim 11, wherein identifying the second vehicle comprises:
transmitting information identifying a location of the first vehicle to a server located remotely from the first vehicle or second vehicle; and
receiving, from the server, information identifying the second vehicle and indicating that the second vehicle is within proximity of the first vehicle.

13. The method of claim 11, wherein the predicted or actual information on a next navigational routing step of the second vehicle comprises an estimated time until the second vehicle performs a left or right turn.

14. The method of claim 11, wherein the predicted or actual information on a next navigational routing step of the second vehicle comprises an estimated time until the second vehicle performs a lane change.

15. The method of claim 11, further comprising:
transmitting, to the second vehicle, information indicating that the first vehicle may soon engage in a lane bypass maneuver.

16. The method of claim 11, further comprising:
initiating, at a vehicle, a navigation session;
providing a location of the vehicle to a remote server;
receiving information on local points of interest in vicinity of the vehicle's location from the remote server; and
displaying, at the vehicle, local points of interest on a navigation map.

17. The method of claim 16, wherein the local points of interest are contributed by members of the public.

18. The method of claim 16, further comprising enabling at least one vehicle self-regulation function based on a determination that the vehicle is within vicinity of a local point of interest.

19. The method of claim 16, wherein a local point of interest from the local points of interest comprises signage related to at least one government-imposed driving restriction.

20. The method of claim 19, further comprising causing a transmission of information identifying a violation of the at least one government-imposed driving restriction to a government authority.
